(19) United States
(12) Patent Application Publication
(10) Pub. No.: US 2010/0044176 A1
(43) Pub. Date: Feb. 25, 2010

(54) FORCE TRANSMISSION DEVICE

(75) Inventor: Benjamin DANIEL, Pforzheim (DE)

Correspondence Address: SIMPSON & SIMPSON, PLLC, 5555 MAIN STREET, WILLIAMSVILLE, NY, 14221-5406, US

(73) Assignee: LUK LAMELLEN UND KUPPLUNGSBAU BETEILIGUNGS KG, Buehl (DE)

(21) Appl. No.: 12/608,145

(22) Filed: Oct. 29, 2009

Related U.S. Application Data
(63) Continuation of application No. PCT/DE2008/000658, filed on Apr. 17, 2008.

(30) Foreign Application Priority Data
May 14, 2007 (DE) 10 2007 022 543.3

(51) Int. Cl. F16H 45/02

(52) U.S. Cl. 192/3.29

(57) ABSTRACT

A force transmission device (1) disposed in a drive train between an engine and a transmission, including a housing including a housing part (10.1), wherein the housing part is formed as an input (E) and connected with an impeller (P) of a hydrodynamic machine, an output (A), a switchable clutch device (6) disposed between the input (E) and the output (A), which clutch device can be actuated by a piston element (8) and guided on the housing part (10.1) in a slidable, pressure-tight manner in an axial direction, and wherein the piston element can be pressurized with a medium by forming a variable chamber (9) that can be pressurized with the medium and means (16) for creating a non-rotational lock between the housing part (10.1) and the piston element (8), wherein the means (16) for creating the non-rotational lock at least comprises a spring device (17, 17.1, 17.2).

### CROSS-REFERENCE TO RELATED APPLICATIONS

This application is filed under 35 U.S.C. §120 and §365(c) as a continuation of International Patent Application PCT/DE2008/000658, filed Apr. 17, 2008, which application claims priority from German Patent Application No. 10 2007 022 543.3, filed May 14, 2007, which applications are incorporated herein by reference in their entireties.

### FIELD OF THE INVENTION

The invention broadly relates to automobile transmissions, more specifically to a force transmission device.

### BACKGROUND OF THE INVENTION

Power transmission devices for application between an engine and a transmission assembly are known in a plurality of prior art embodiments. In general, these devices each comprise an input and an output between which a hydrodynamic component, in particular a hydrodynamic speed or torque converter for hydrodynamic force transmission is disposed, comprising at least an impeller and a turbine wheel, together forming a chamber that can be filled or is filled with operating medium, as well as a device in the form of a lock-up clutch for bypassing the hydrodynamic power branches of the hydrodynamic component.

The lock-up clutch in this case comprises at least two clutch parts that can be brought together in active connection by means of an actuating device. The lock-up clutch serves for non-rotatable coupling between the input and the output or between the impeller and turbine wheel.

The actuating device in the simplest case comprises a piston that can be shifted in axial direction, which acts on individual clutch parts. When the force transmission device is executed in triple channel design, the piston element is pressurized through a chamber that can be pressurized with a pressure or control means, in general oil, wherein the pressure is adjustable independently of the pressure in the other two pressure chambers of the force transmission device.

The chamber can be pressurized with pressure medium and is formed by the housing and the piston element by means of its pressure and liquid-tight guide on the housing. The output, in particular the transmission input shaft, disposed downstream of the transmission assembly unit is supported by means of a bearing arrangement on the housing part forming the input and is connected with the impeller, in particular a hub element connected with the latter non-rotatably. The piston element is guided in a slidable manner in axial direction on the housing, in particular in the area around its internal circumference on the hub element.

To prevent rotation of the piston element relative to the cover, owing to its inertial forces upon engine excitation and thus to avoid possible wear of piston seals, the piston element is secured, in the cover hub, in a form-closed manner against rotation. Besides providing the cover hub, this necessitates providing the corresponding connection channels for supplying the pressure chamber through the hub element as well as through complementary torsion control elements on the piston element and hub. To prevent stresses and to ensure safe guidance of the piston element, production and assembly are carried out very accurately.

A force transmission device is anticipated in the DE 44 33 256 A1 document, in which the axially movable piston is connected by means of a circular component provided with axially running holders, which engage non-rotatably with the housing in cutouts and/or on embossed surfaces and/or on other means provided on the piston for that purpose. With this, it is achieved that the piston features the same rotation speed as the housing and on the other hand that the discs carrying the frictional linings feature the same rotation speed as the turbine. The arrangement of the means for non-rotatable coupling takes place in radial direction outside the piston hub, thus, in radial direction based on the rotational axis relatively far outside on a large diameter.

The invention is therefore based on the task to further develop a force transmission device, in particular an embodiment in triple channel design in a manner such that the production and assembly scope is reduced, wherein the design should be simplified in overall by guaranteeing safe functionality, in particular the non-rotational locking of the piston element relative to the internal wall of the housing and noise development of non-rotational lock should be reduced.

### BRIEF SUMMARY OF THE INVENTION

The present invention broadly comprises a force transmission device to be disposed in a drive train between an engine and transmission in at least a triple channel design comprises a drivable housing part formed as input and a housing part that can be or is connected with an impeller of a hydrodynamic machine, an output and a switchable clutch device disposed between an input and an output. The switchable clutch device can be actuated via a piston element, guided in pressure-tight manner, slidable in axial direction on the housing part under the formation of a variable chamber or one that can be pressurized with pressure medium. In one embodiment, between the housing part and piston element, means are provided for non-rotational locking.

In one embodiment, the non-rotational locking comprises at least a spring device. In one embodiment, the application of an additional force on the piston element via the spring device that together with the actuation force generated on the piston element, in particular a piston surface, through the pressure in the chamber pressurized with pressure medium is combined or superimposed to form a resulting actuation force. Depending on the design of the spring device, force-distance control can be implemented on the piston element, in that the resulting actuation force is influenced by the two components—actuating pressure inside the chamber and spring force.

In one embodiment, the device has a triple channel design that includes three pressure chambers, wherein a first pressure chamber is formed by a work chamber of the hydrodynamic machine, a second pressure chamber is formed by an internal chamber created between the internal circumference of the housing and the external circumference of the hydrodynamic machine and the third pressure chamber is formed by the chamber that can be pressurized with pressure medium, wherein at least one connection is assigned respectively to each individual pressure chamber. The term connection is to be understood purely in functional manner with regard to the operating medium supply or drainage and is not limited to a concrete design embodiment.

In one embodiment, the chamber for pressurizing the piston, is pressurized independently of the other pressure chambers. In one embodiment, particularly for saving assembly space, the spring device is disposed coaxially to the rotation axis of the force transmission device. In different embodiments, the non-rotational lock can be disposed, depending on the particular design of the spring device, in a simple manner at different diameters about the rotation axis.

In one embodiment, smaller and stiffer spring devices are used, preferably a plurality thereof, consists of the eccentric disposition of the rotation axis, wherein the spring devices are preferably disposed symmetrically about the rotation axis of the force transmission device.

In one embodiment, to implement non-rotational lock with an axial compensation, coupling of an individual spring device with the piston element and with the housing part in their axial end areas is provided by two connections that are both non-rotational, however, wherein one of the two allows an axially relative movement in the connection between the elements to be connected, in the first connection—between the spring device and housing part and/or the second connection between the piston element and spring device. In one embodiment, the individual spring device is either connected non-rotatably to an axial end section and fixedly in axial direction with the housing part and on the lower end area it is connected non-rotatably and in axial direction with the piston element allowing a relative movement between on the piston element and the spring device.

In one embodiment, the spring device is connected non-rotatably to an axial end section and in axial direction fixedly with the piston element and on the other end section non-rotatably and in axial direction it is connected with the housing part allowing a relative movement between the housing part and the spring device. In one embodiment, additional fastening or coupling areas are provided on the spring device, in which at least a non-rotatable coupling is provided. In one embodiment, these fastening or coupling areas can be formed either directly depending on embodiment formed by the jacket surface of the spring device or on these protrusions specially formed for this purpose, which extend in axial and/or radial direction and/or circumferential direction.

In one embodiment, the fastening or coupling surfaces are formed depending on the connection types realized in non-rotatable connections. In one embodiment, if non-rotatable connection is realized through fastening elements, then fastening areas are provided preferably on the individual spring devices executed in the form of flanges, viewed in radial direction, and allow insertion of fastening elements in axial direction. In such an embodiment, the fastening elements serve for fixation in circumferential direction and if assembled with clearance they also provide the possibility of relative movement between the elements to be connected by fastening elements with one another.

In one embodiment, the non-rotatable connection which disables relative movement in the axial direction is either permanent or detachable. In one embodiment, the non-rotatable connection is permanent, and achieved by means of riveting. In one embodiment, the connection is established generally through force-closure or form-closure.

The possibility of axial relative movement is established in the simplest manner by form-closure, in that the spring device is hung in with an end section on the connection element with an axial clearance. In accordance with a particularly advantageous embodiment, the individual spring device is executed as a spring device with a nonlinear spring characteristic curve, in particular disc spring. Since the disc spring is characterized by a non-linear spring characteristic, in a particularly optimum embodiments, this can be used for force-distance control on the piston element and depending on the embodiment and on the created spring characteristic, it can influence the resulting actuating force.

In a further embodiment, the means of providing a non-rotational lock comprise at least a further spring device, preferably also in the form of a disc spring parallel to the first disc spring and is disposed coaxially to the rotation axis of the force transmission device, so that both disc springs are connected in parallel. In this embodiment, the required spring distance can be reduced whilst retaining the same force.

To uniformly pressurize the chamber, which can be filled with pressure medium, in the embodiments with disc springs on both sides of disc spring jacket surfaces, the latter are provided with overflow openings in their end areas for pressure medium or in individual connection elements, so that the medium is provided on the internal and external jacket surface of the disc springs. These overflow openings can be provided in the form of passage openings or slits in the jacket surface or they can be implemented in the connection areas with the connection elements, wherein in the edge-end area of the spring device, in the form of design protrusions, the latter can even be prone to deformation under pressure, which, after attaining minimum pressure on the internal side of the disc springs, enable the formation of a slit or enlargement of an existing slit and hence provide a transition of pressure medium in the radial direction.

In one embodiment utilizing a spring device as the means of non-rotationally locking, the spring device is installed with initial stress.

The solution according to the invention is particularly suitable for force transmission devices in triple channel design, i.e. with a separate chamber assigned to the piston element and which can be pressurized with pressure medium. The force transmission device comprises a hydrodynamic machine or component, comprising at least an impeller and a turbine wheel. Furthermore, in a particularly advantageous embodiment with hydrodynamic speed/torque converter, at least a stator wheel is still provided.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is an axial cross-section of a force transmission device, and illustrates an embodiment which includes a non-rotational lock with a spring device, according to the current invention;

FIG. 2 illustrates an exemplary embodiment of a spring device in the form of a disc spring;

FIGS. 3a and 3b illustrate a front and a rear view of an embodiment of a non-rotational lock according to FIG. 1;

FIG. 4a illustrates an embodiment of a disc spring with passage openings in the form of slits;

FIG. 4b illustrates an embodiment of a disc spring with overflow openings in the form of open-edge slits on a second axial end area; and,

FIG. 5 illustrates a further embodiment of spring connection based on the embodiment shown in FIG. 1.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

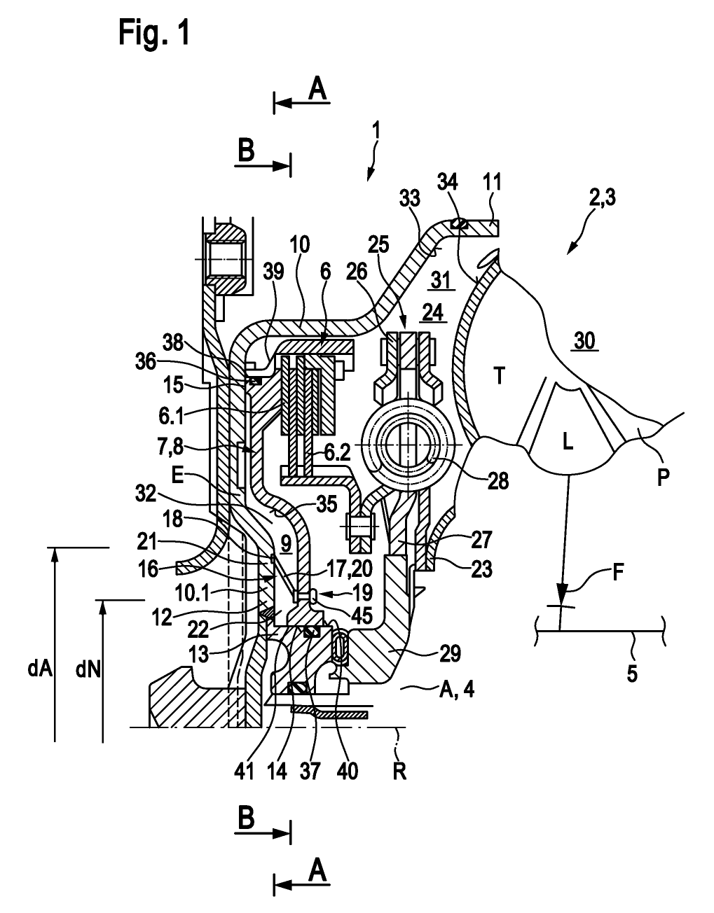

Referring now to the figures, FIG. 1 clarifies force transmission device 1, in an axial section, with non-rotational lock executed according to the invention. This comprises input E that can be coupled with a drive shaft of a drive unit at least indirectly, i.e. directly or via further transmission means and at least output A. Output A can be coupled with a driven part of a drive train and is formed by a shaft, in particular transmission input shaft 4. Between input E and output A hydrodynamic component 2 is interposed. Hydrodynamic component 2 comprises a blade wheel, viewed in power flow direction from input E to output A, acting as impeller P and connected with input E and a further blade wheel acting as turbine wheel T and coupled indirectly with at least output A. In the depicted case is hydrodynamic component 2 preferably executed as hydrodynamic speed/torque converter 3, whereby the latter still comprises at least stator wheel L. The latter is supported via freewheel F on a fixed or rotating element—here support shaft 5. Hydrodynamic component 2 makes the force transmission in a hydrodynamic power branch possible. Force transmission device 1 further comprises a device for at least partially bypassing the hydrodynamic power branch, preferably in the form of lock-up clutch 6, comprising first and second clutch parts 6.1, 6.2, which can be brought in active connection with one another. Clutch parts 6.1 and 6.2 comprise at least one disc respectively in an embodiment as a frictional clutch in the form of a disc clutch. Actuator unit 7 that in the simplest case comprises piston element 8 that can be pressurized with pressure medium is provided for actuation. Piston element 8 is thereby tight to pressure medium and is guided in a slidable manner in axial direction by forming chamber 9 on input E that can be pressurized with pressure medium, in particular an element coupled non-rotatably with the latter. As pressure medium, the operating medium of hydrodynamic component 2 finds application in the simplest case. Input E is connected non-rotatably with the impeller P of hydrodynamic component 2 at least indirectly, here via housing 10. Housing 10 rotates with and comprises at least housing part 10.1, which is coupled non-rotatably with impeller shell 11 connected with impeller P or forms an integral assembly unit with the latter and formed by cover 12. The guide of piston element 8 in the area of its internal circumference 14 is provided on hub 13 connected non-rotatably with housing part 10.1, in particular cover 12, or formed on the latter. In the area around external circumference 15, piston element 8 is guided, in a manner that is tight to pressure and liquid, on an element connected non-rotatably with housing part 10.1, here on first clutch part 6.1.

According to the invention, in particular cover 12 means 16 for non-rotational lock are provided between piston element 8 and housing part 10.1. These comprise at least spring device 17 between piston element 8 and housing part 10.1, in particular cover 12. Means 16 are free from direct non-rotatable, in particular form-closed connection between hub 13 and piston element 8 in the area of its internal circumference 14. Means 16 for realizing a non-rotational lock serve for fixing piston element 8 in circumferential direction, opposite housing part 10.1, in particular cover 12. What is decisive is that a non-rotational lock is guaranteed here even under complete deflection, thus axial motion of piston element 8 in the actuated state of the lock-up clutch 6. Spring device 17 is connected non-rotatably with the two elements to be locked against rotation relative to one another. The connections are designated here with 18 between housing part 10.1 and spring device 17 and with 19 between spring device 17 and piston element 8. At least one of connections 18 or 19 is dimensioned such that it also allows a relative movement in axial direction, between spring device 17 and the connection element—piston element 8 or housing part 10.1. In the depicted case, a relative movement is allowed in the axial direction, between spring device 17 and housing part 10.1. Second non-rotatable connection 19, for example, is formed as a non-detachable connection and is either realized by a form-closure so that no relative movement is possible between spring device 17 and the connection element, in the form of piston element 8. First non-rotatable connection 18, for example, is realized by a form-closure, which is nonetheless not fixed in axial direction, with respect to positional assignment between spring device 17 and the connection element, here to housing part 10.1, but allows displacement or relative movement or compensation movement. Spring device 17 is disposed coaxially to rotation axis R of force transmission device 1, furthermore coaxially to the middle or rotation axis of housing 10 and of piston element B. In accordance with a particularly advantageous embodiment, spring device 17 is executed as disc spring 20. This can be characterized, depending on the design by different non-linear curves. Spring device 17 offers the advantage of superposition of the pressure in the chamber that can be pressurized with pressure medium with the pressure exerted by spring device 17 on piston element 8, so that by dimensioning spring device 17, different modified actuating devices can be provided with regard to the force-distance control of the piston element. In accordance with FIG. 1, second connection 19 is executed as a non-rotatable, non-detachable connection. This does not allow any relative movement in axial direction. In the simplest case, connection 19 is executed as a riveted connection by means of a plurality of rivets 45 equally spaced in circumferential direction on second axial end area 22 of disc springs 20. The axial relative movement for instance is realized by hanging spring device 17 with its first axial end area 21 on housing part 10.1, in particular cover element 12. Also the reverse is considerable, here nonetheless a depicted constellation, thus non-rotatable coupling of spring device 17, preferably by form-closure freely of the possibility of equalizing movement and preferably non-detachably with cover 12 and linkage with detachable connection 19 on piston element 8 in second axial end area 22. Axial end areas 21, 22 are meant for embodiment as disc springs 20 through the external diameter dA and the nominal, or inner diameter dN, wherein the latter, depending on the embodiment can be assigned to the first or second axial end area. The latter form fastening areas 49 and 50, alternatively, fastening areas 49 and 50 are disposed on the latter. Fastening areas 49 and 50 can thereby be provided on jacket surface 42 or are formed by protrusions which are aligned in axial and/or radial direction. The installation takes place with nominal diameter dN oriented towards piston element 8 and provided with prestressing.

FIG. 1 clarifies an example of force transmission device 1 with piston element B guided on cover hub 13. There are no limitations with regard to further embodiment of force transmission device 1. Turbine wheel T is at least coupled indirectly non-rotatably with output A. Clutch device 6 is preferably formed as a frictional clutch. This comprises at least first clutch part 6.1 and second clutch part 6.2, which can be brought in active connection with one another for the purpose of force transmission by means of actuating unit 7. Second clutch part 6.2 is at least indirectly connected non-rotatably with output A. Output A for instance is formed as a hollow shaft. The coupling occurs via hub 23 connected non-rotatably with the latter.

Impeller P is connected non-rotatably with input E of force transmission device 1. Depending on the embodiment of force transmission device 1, the connection occurs directly or selectively detachably, wherein in the latter case a corresponding impeller clutch—not depicted here—is provided, which selectively allows coupling or decoupling of the impeller from input E. The coupling according to the first embodiment—not depicted here—is provided in the simplest case by means of housing 10 or housing part 10.1 in the form of cover 12 that is connected non-rotatably with impeller P or impeller shell 11 and holds hydrodynamic component 2, in particular turbine wheel T, in axial and radial direction by forming internal chamber 24 in axial direction, holding clutch device 6 and encloses it in circumferential direction. This type of embodiment, thus non-rotatable coupling of cover 12 with impeller shell 11 involves housing that rotates in unison, which is executed as single or multiple part. In embodiments with an impeller clutch, further housing is provided, which encloses hydrodynamic component 2 and switchable clutch device 6. This is generally fixed.

Lock-up clutch 6 is executed as a switchable clutch. This is generally formed as a mechanical clutch, preferably as a frictional clutch that is operable with slip. In the simplest case, it is formed in disc design, preferably as a disc clutch. First clutch part 6.1 is at least indirectly connected non-rotatably with input E and second clutch part 6.2 with output A of force transmission device 1. At least indirectly implies either directly or via further transmission elements. In the depicted case, the link of first clutch part 6.1 occurs directly on cover 12, connected non-rotatably with input E or forms the latter. Second clutch part 6.2 is at least indirectly connected non-rotatably with output A of force transmission device 1, in particular with transmission input shaft 4. In the depicted case, coupling occurs indirectly, thus not directly but for instance via device 25 for damping vibrations, which is in the form of a torsion vibration damper. In this case, depending on design, a mechanical torsion vibration damper or a damper involving a different functioning principle can be involved. This comprises at least primary part 26 and secondary part 27, which are rotatable in a manner limited relative to one another in circumferential direction. Primary part 26 and secondary part 27 are coupled to it by means 28 for spring and/or damper coupling with one another. Depending on the embodiment, means 28 in pure mechanical apparatus comprises spring units that also assume damping function besides torque transmission. Device 25 for damping vibrations thereby acts in power flow like an elastic clutch. For this purpose, second clutch part 6.2 is connected non-rotatably with primary part 26. Secondary part 27 is at least indirectly coupled non-rotatably, preferably via hub 29, with transmission input shaft 4 and thus coupled with output A. Furthermore, a further non-rotatable connection exists between primary part 26 and turbine wheel T.

All elements, hydrodynamic component 2, lock-up clutch 6, device for damping vibrations 25 are disposed coaxially to one another and to rotation axis R of force transmission device 1. Individual pressure chambers are created based on the arrangement. Force transmission device 1 is thereby formed as a triple channel system. This means that it is provided at least with three possible pressure chambers 30, 31 and 32. First pressure chamber 30 is formed by the work chamber of hydrodynamic component 2, thus, it is formed by the chamber enclosed by impeller P and turbine wheel T. Second pressure chamber 31 is formed by internal chamber 24, which is limited in particular by internal circumference 33 of housing 10 and external circumference 34 of hydrodynamic component 2, in particular the individual blade wheels, in which device 25 for damping vibrations and lock-up clutch 8 are disposed. Third pressure chamber 32 is assigned to piston element 8 and is formed between the latter and housing 10 and corresponds to chamber 9. The formation of third pressure chamber 32 occurs between a partial section formed by internal circumference 33 of the housing wall as well as face side 35 of piston element B oriented towards internal circumference 33. Thereby, pressure chamber 32 can be pressurized with the pressure for piston element 8 for closing lock-up clutch 6. This pressure can be set preferably variably. The pressurizing pressure on piston element 8 is further determined by the spring force on the piston surface, in particular face surface 35, which in addition with the pressurizing pressure inside chamber 9 forms the total pressure on piston element 8 and thus characterizes the actuating force. Hydrodynamic component 2, in particular force transmission device 1 is assigned to corresponding connections, wherein the term connection here is understood functionally and does not experience any restriction with regard to the constructive embodiment. What is meant is only a connection to pressure chambers 30 to 32. A first connection is thereby assigned to first pressure chamber 30, a second connection is assigned to second pressure chamber 31 and a third connection is assigned to third pressure chamber 32. The coupling of the individual pressure chambers 30 to 32 with the corresponding connections can occur via the channels, which can be implemented in different designs. This can involve connection holes or shafts, axles, channels located in rotating passages. Reference here is drawn only to the functional coupling. For cooling purposes of the operating medium in general a part of the operating medium is guided outside the circuit in side the work chamber. The flow through hydrodynamic component 2 can occur either centripetally or centrifugally depending on direction, wherein, in the case of centrifugal flow, supply occurs via the first connection to the work chamber. The pressure difference between pressure chamber 32 and 31 determine the position of piston element 8. Thereby, the force transmission can occur both hydrodynamically as well as mechanically and hydrodynamically combined, in particular when lock-up clutch 4 is operated with slip, whereas at the same time a partial force transmission still occurs via hydrodynamic component 2. In the case of desired bypass of the hydrodynamic force transmission, the removal of the hydrodynamic power branch, lock-up clutch 6 will be activated. For this, pressure chamber 32 will be pressurized. Piston element 8 is moved in axial direction and generates a frictional closure between first clutch part 6.1 and second clutch part 6.2. The pressure-tight embodiment of pressure chamber 32, in particular chamber 9 is implemented via appropriate sealing arrangements 36 and 37, wherein first sealing arrangement 36 is disposed between external circumference 15 of piston element 8 and surface area 38 of protrusion 39 carrying first clutch part 6.1, whereas second sealing arrangement 37 is disposed between surface area 40 on hub 13 forming the external circumference and surface area 41 in radial direction facing rotation axis R, thus disposed in internal circumference 14 of piston element 8. The pressure medium is supplied via corresponding connection channels that are guided through hub 13.

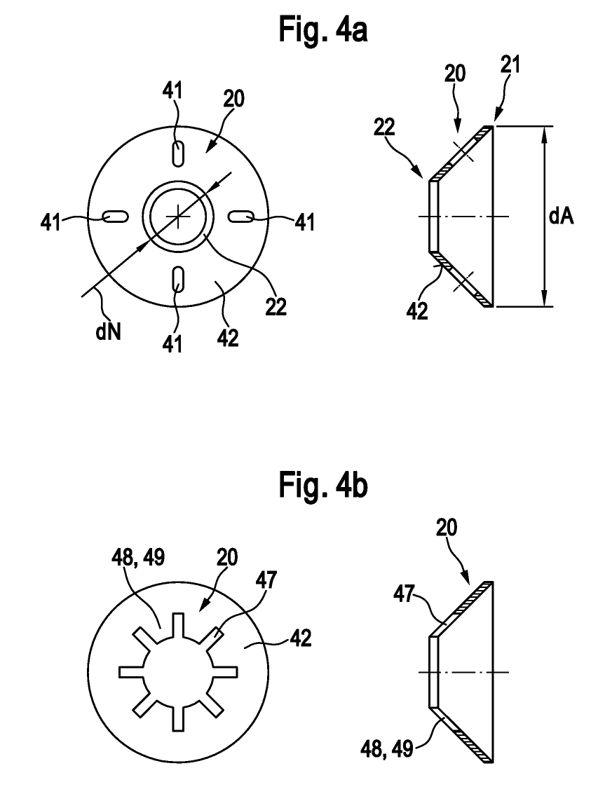

FIG. 1 thereby clarifies a particularly advantageous embodiment. Other possibilities are considerable. The link of spring device 17 to the internal wall of housing part 10.1 is provided here and on the piston surface or face surface 35 towards this, wherein the link on piston element 8 preferably occurs as much as possible in the radial internal area, thus in the area around hub 13. In the depicted case, the link of spring device 17 lies in the surface areas aligned in axial direction. It is also considerable that the link be established in surface areas aligned in radial direction. Accordingly, individual connections 18 and 19 would have to be specified. Disc springs 20 in the depicted embodiment with extension of jacket surface 42 over the entire axial extension of chamber 9 is provided such that penetration or passage of control or operating medium into chamber 9 is possible either in the connection area, i.e. within individual connections 18, 19 and/or at least a passage opening, preferably a plurality of passage openings or slit 41 in jacket surface 42 of disc springs 20 are provided, which allow passage of operating medium also through spring device 17. Furthermore, the operating medium passage can also occur between the suspension areas when it is ensured that no complete sealing of pressure chamber 32 occurs through disc springs 20. Individual passage openings 41 can be disposed in circumferential direction, relative to one another, at the same distance or at different spacing intervals. The first possibility is exemplarily clarified in two views—one view from the front and one cross-sectional view of disc spring 20 in FIG. 4a. Passage openings 41 are integrated in jacket surface 42. These can be executed in different ways in regard to its geometry, for instance, also in the form of circular openings. In contrast, FIG. 4b clarifies an embodiment provided with open-edge slits 47 or cutouts that extend in jacket surface 42 in the direction towards first end area 21 under the formation of fingers 48, in second axial end area 22. Fingers 48 thereby form fastening areas 49, in which or through which the fastening means for non-rotatable coupling with the connection elements are guided, wherein the latter can also be used for coupling in axial direction.

Piston element 8 is free from direct, non-rotatable coupling with the hub 13 that means a connection in the radial internal area. Spring device 17 is preferably executed as a disc spring 20 disposed coaxially to the rotation axis. The application of any spring devices with preferably a non-linear curve is considerable, however, in order to realize a force-distance-control for piston element 8 adapted to concrete application requirements.

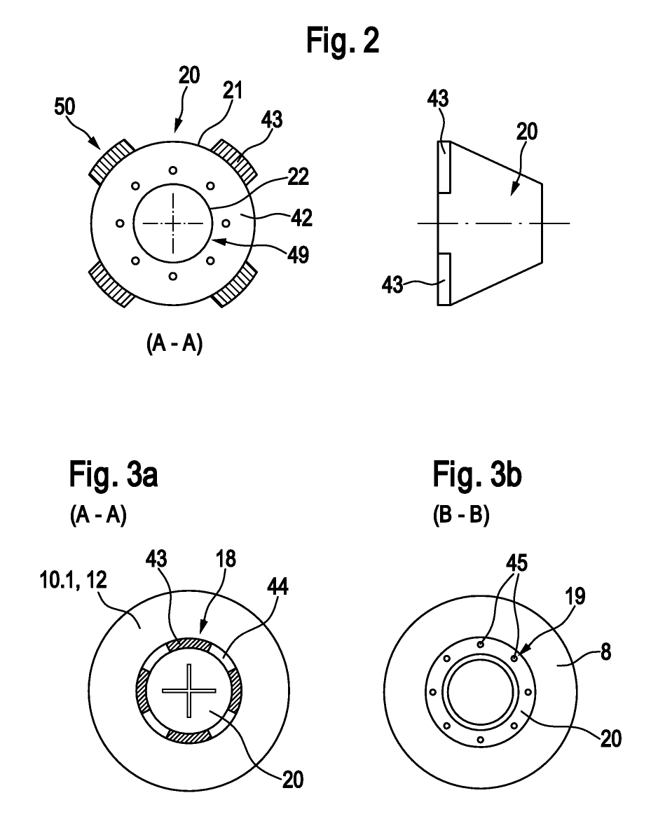

FIG. 2 clarifies a possible embodiment of disc springs 20 in a schematized and simplified depiction in a view A-A in the assembly position according to FIG. 1 without further elements. Visible from the above are first axial end area 21 and second axial end area 22, wherein first end area 21 is characterized by protrusions 43 aligned in axial and/or radial direction, which engage with complementary recesses 44 on the connection element, in particular in housing part 10.1. Protrusions 43 are circular-segment shaped and extend over an angular area in circumferential direction. Individual protrusions 43 are preferably executed with the same dimensions and are disposed equally spaced from one another in circumferential direction. It is possible to deviate from an identical embodiment when it is ensured that the center of gravity of spring device 17 remains in the area of the rotation axis R in assembly position.

Protrusions 43 engage with complementary recesses 44 on cover 12 according to FIG. 3a in the view A-A and are suspended in the latter. Also recesses 44 are disposed in a corresponding manner in the circumferential direction and distributed in the cover element. Protrusions 43 are executed in a manner that, viewed in assembly position, they are aligned directly in radial direction or they are inclined to the latter, so that the engagement with cover 12 occurs like a barbed hook, in that, upon activating piston element 8, the surface areas aligned with piston element 8 of protrusions 43 in recesses 44, in particular lie on these surface areas aligned in opposite direction. Other embodiments are considerable. In this embodiment, the non-rotatable coupling occurs on second end area 22 on piston element 8 via riveted connections 45 in a view B-B according to FIG. 1 on disc springs 20.

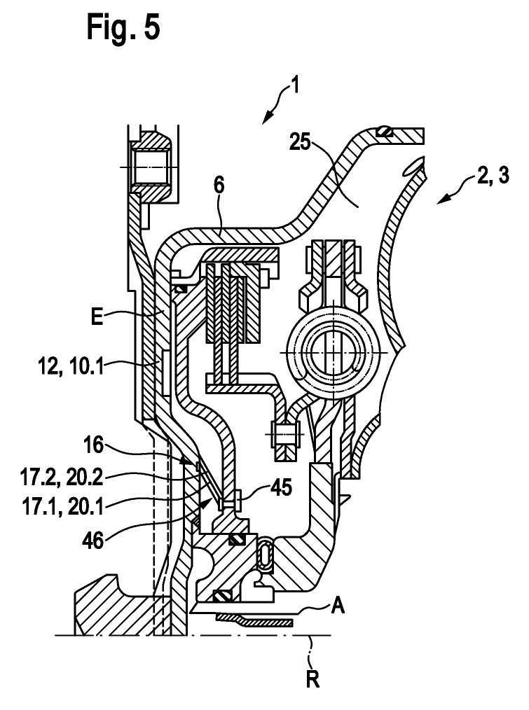

FIGS. 1 to 3 clarify an embodiment with disc spring 20; moreover, it is possible also to use spring connections in particular, when the spring distance may not be particularly large. FIG. 5 clarifies an exemplary embodiment with parallel connection of two spring devices 17.1, 17.2, in particular disc springs 20.1, 20.2. Also this parallel connection 46 is disposed coaxially to rotation axis R. The individual connection of spring device 17.1, 17.2, in particular disc springs 20.1 and 20.2 with piston element 8 and housing part 10.1 is preferably executed in analog to the one described in FIG. 1.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### LIST OF REFERENCE SYMBOLS

1 force transmission device
2 hydrodynamic component
3 speed/torque converter
4 transmission input shaft
5 support shaft
6 device for bypassing the hydrodynamic power flow
6.1 first clutch part
6.2 second clutch part
7 actuator unit
8 piston element
9 chamber
10 housing
10.1 housing part
11 impeller shell
12 cover
13 hub
14 internal circumference
15 external circumference
16 means for realizing a non-rotational lock
17 spring device
17.1, 17.2 spring device
18 non-rotatable connection
19 non-rotatable connection
20 disc spring
20.1, 20.2 disc springs
21 axial end area
22 axial end area
23 hub
24 internal chamber
25 device for damping vibrations
26 primary part
27 secondary part
28 means for spring and/or damping clutch
29 hub
30 pressure chamber
31 pressure chamber
32 pressure chamber
33 internal circumference
34 external circumference
35 face surface
36 sealing arrangement
37 sealing arrangement
38 surface area
39 protrusion
40 surface area
41 passage opening
42 jacket surface
43 protrusion
44 recess
45 rivet
46 parallel connection
47 open-edge slit
48 finger
49 fastening area
50 fastening area
E input
A output
P impeller
T turbine wheel
L stator wheel
F freewheel
R rotation axis
dA outside diameter
dN nominal diameter

What we claim is:

1. A force transmission device (1) disposed in a drive train between an engine and a transmission, comprising:
a housing including a drivable housing part (10.1), wherein the drivable housing part is formed as an input (E) and connected with an impeller (P) of a hydrodynamic machine;
an output (A);
a switchable clutch device (6) disposed between the input (E) and the output (A), which clutch device can be actuated by means of a piston element (8) and guided on the housing part (10.1) in a slidable and pressure-tight manner in an axial direction; and,
wherein the piston element can be pressurized with a pressure medium by forming a variable chamber (9) that can be pressurized with the pressure medium and means (16) for creating a non-rotational lock between the housing part (10.1) and the piston element (8), wherein the means (16) for creating the non-rotational lock at least comprises a spring device (17, 17.1, 17.2).

2. The force transmission device (1) according to claim 1, further comprising:
a first pressure chamber (30) that comprises a work chamber of the hydrodynamic machine;
a second pressure chamber (31) that is formed by an internal chamber (24) formed between an internal circumference (33) of the housing (10) and an external circumference (34) of the hydrodynamic machine; and,
a third pressure chamber (32) that is formed by the variable chamber (9), wherein at least a first, second, and third connection is assigned respectively to each of the first, second, and third pressure chambers (30, 31, 32).

3. The force transmission device (1) according to claim 1, wherein the spring device (17, 17.1, 17.2) is disposed coaxially with a rotation axis (R) of the force transmission device (1).

4. The force transmission device (1) according to claim 1, wherein the spring device (17, 17.1, 17.2) is disposed eccentrically to a rotation axis (R) of the force transmission device (1).

5. The force transmission device (1) according to claim 1, wherein the spring device (17, 17.1, 17.2) includes fastening or coupling surfaces (49, 50) respectively for first and second non-rotatable connections (18, 19) in a first axial end area (21) for coupling with the housing part (10.1), and in a second axial end area (22) for coupling with the piston element (8).

6. The force transmission device (1) according to claim 5, wherein the end areas (21, 22) are formed by protrusions (43), and the fastening and coupling surfaces (49, 50) are formed by a jacket surface (42), the protrusions (43), or both.

7. The force transmission device (1) according to claim 5, wherein the first connection (18) of the spring device (17, 17.1, 17.2) is formed non-rotatably with the housing part (10.1) and fixed in axial direction and the second connection (19) is arranged non-rotatably between the spring device (17, 17.1, 17.2) and the piston element (8), wherein relative movement between the piston element (8) and the spring device (17, 17.1, 17.2) is allowed.

8. The force transmission device (1) according to claim 5, wherein the second connection (19) of the individual spring device (17, 17.1, 17.2) is formed non-rotatably with the piston element (8) and fixed in axial direction and the first connection (18) is arranged non-rotatably between the spring device (17, 17.1, 17.2) and housing part (10.1), wherein relative movement between the housing part (10.1) and spring device (17, 17.1, 17.2) is allowed.

9. The force transmission device (1) according to claim 7, wherein the first and second non-rotatable connections (18, 19) are non-detachable in axial direction.

10. The force transmission device (1) according to claim 9, wherein the first or second non-rotatable connections, or both, are provided through a rivet connection.

11. The force transmission device (1) according to claim 9, wherein the first or second non-rotatable connections, or both, are provided through form-closure.

12. The force transmission device (1) according to claim 7, wherein the first and second non-rotatable connections (18, 19) between the spring device (17, 17.1, 17.2) and the piston element (8) and/or the housing part (10.1) are detachable.

13. The force transmission device (1) according to claim 12, wherein the first or second non-rotatable connections, or both, are either force-closed or form-closed.

14. The force transmission device (1) according to claim 12, wherein the spring device (17, 17.1, 17.2) is hung with an end area (21, 22) on the piston element (8) or on the housing part (10.1).

15. The force transmission device (1) according to claim 1, wherein the spring device (17, 17.1, 17.2) is disposed with protrusions between the piston element (8) and the housing part (10.1).

16. The force transmission device (1) according to claim 1, wherein a characteristic of the spring device (17, 17.1, 17.2) can be set.

17. The force transmission device (1) according to claim 1, wherein the spring device (17, 17.1, 17.2) is characterized by a non-linear curve.

18. The force transmission device (1) according to claim 1, wherein the spring device (17, 17.1, 17.2) is executed as at least one disc spring (10, 20.1, 20.2).

19. The force transmission device (1) according to claim 18, wherein said at least one disc spring comprises at least two disc springs (20.1, 20.2) connected in parallel.

20. The force transmission device (1) according to claim 19, wherein the at least one disc spring (20, 20.1, 20.2) includes passage openings (41).

21. The force transmission device (1) according to claim 19, wherein the at least one disc spring (20, 20.1, 20.2) in an axial end area (21, 22) comprises open-edge slits (47) by forming finger elements (48), wherein at least a part of the finger elements (48) is connected with the piston element (8) or with the housing part (10.1).
